(19) United States
(12) Patent Application Publication
(10) Pub. No.: US 2023/0051447 A1
(43) Pub. Date: Feb. 16, 2023

(54) Quantum Rating System

(71) Applicant: S&P Global Inc., New York, NY (US)

(72) Inventors: Yili Zhang, Logan, UT (US); Jia Zhao, Logan, UT (US); Giles Thompson, London (GB); Lapo Guadagnuolo, London (GB); Marcus Isaac Daley, Provo, UT (US)

(21) Appl. No.: 17/444,042

(22) Filed: Jul. 29, 2021

(51) Int. Cl. G06Q 40/02; G06N 10/00; G06F 17/18

(52) U.S. Cl. CPC G06Q 40/025; G06N 10/00; G06F 17/18

(57) ABSTRACT

A method of rating credit risk is provided. The method comprises calculating a number of credit risk factors associated with a financial instrument, wherein each credit risk factor is calculated iteratively at a first timestep as a discrete probabilistic wave function representing a superposition state of scores. The discrete probabilistic wave function of each credit risk factor is measured after each calculation iteration for the first timestep. The probabilistic wave functions of the credit risk factors are then linearly combined to calculate a discrete probabilistic wave function for a final credit rating of the financial instrument for the first timestep, which is displayed in a user interface. The above steps are repeated for a second timestep using the probabilistic wave functions of the credit risk factors at the first timestep as initial states for the second timestep.

### BACKGROUND INFORMATION

### 1. Field

The present disclosure relates generally to credit risk rating, and more specifically to a method for rating credit risk for financial instruments based on quantum computing.

### 2. Background

When deriving a credit rating for a financial instrument it is not unusual to see an approach where the final rating is a construction based on the interaction of specific factors and sub-factors. Each factor represents a dimension of the analysis that characterizes a specific risk, a financial ratio or any other observable likely to impact the performance of a rating over time. These factors and sub-factors are structured in a pipeline that captures their relationship and links the factors and sub-factors to an indicative rating.

Research on quantum computation and algorithms has been growing in recent years. Quantum computers exploit the unique, non-classical properties of the quantum systems from which they are built, allowing them to process exponentially large quantities of information in only polynomial time. In the same way classical computation quickly branched away from its narrow beginnings facilitating simulations of Newtonian mechanics, the study of quantum algorithms has diverged greatly from simply simulating quantum physical systems to impact a wide variety of fields, including information theory, cryptography, language theory, and mathematics.

Therefore, it would be desirable to have a method and apparatus that take into account at least some of the issues discussed above, as well as other possible issues.

### SUMMARY

An illustrative embodiment provides a computer-implemented method of rating credit risk. The method comprises calculating a number of credit risk factors associated with a financial instrument, wherein each credit risk factor is calculated iteratively at a first timestep as a discrete probabilistic wave function representing a superposition state of scores. The discrete probabilistic wave function of each credit risk factor is measured after each calculation iteration for the first timestep. The probabilistic wave functions of the credit risk factors are then linearly combined to calculate a discrete probabilistic wave function for a final credit rating of the financial instrument for the first timestep, which is displayed in a user interface. The above steps are repeated for a second timestep using the probabilistic wave functions of the credit risk factors at the first timestep as initial states for the second timestep.

Another illustrative embodiment provides a system for rating credit risk. The system comprises a storage device configured to store program instructions and one or more processors operably connected to the storage device and configured to execute the program instructions to cause the system to: calculate a number of credit risk factors associated with a financial instrument, wherein each credit risk factor is calculated iteratively at a first timestep as a discrete probabilistic wave function representing a superposition state of scores; measure, after each calculation iteration, the discrete probabilistic wave function of each credit risk factor for the first timestep; linearly combine the probabilistic wave functions of the credit risk factors to calculate a discrete probabilistic wave function for a final credit rating of the financial instrument for the first timestep; display, in a user interface, the discrete probabilistic wave function of the final credit rating for the first timestep; and repeat the above steps for a second timestep, wherein the probabilistic wave functions of the credit risk factors at the first timestep serve as initial states for the second timestep.

Another illustrative embodiment provides a computer program product for rating credit risk. The computer program product comprises a computer-readable storage medium having program instructions embodied thereon to perform the steps of: calculating a number of credit risk factors associated with a financial instrument, wherein each credit risk factor is calculated iteratively at a first timestep as a discrete probabilistic wave function representing a superposition state of scores; measuring, after each calculation iteration, the discrete probabilistic wave function of each credit risk factor for the first timestep; linearly combining the probabilistic wave functions of the credit risk factors to calculate a discrete probabilistic wave function for a final credit rating of the financial instrument for the first timestep; displaying, in a user interface, the discrete probabilistic wave function of the final credit rating for the first timestep; and repeating the above steps for a second timestep, wherein the probabilistic wave functions of the credit risk factors at the first timestep serve as initial states for the second timestep.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 depicts a block diagram of a quantum rating system in accordance with an illustrative embodiment;

FIG. 3 depicts a diagram illustrating examples of rating state evolutions over time resulting from different volatilities;

FIG. 4 depicts a diagram illustrating credit risk factors modeled in a Quantum Rating System in accordance with an illustrative embodiment;

FIG. 5 depicts a diagram illustrating final credit ratings as shifting probability distributions over time in accordance with an illustrative embodiment;

FIG. 6 depicts a flowchart illustrating a process for rating credit risk at a given timestep in accordance with an illustrative embodiment;

FIG. 7 depicts a flowchart illustrating a process for calculating probabilistic wave functions in accordance with an illustrative embodiment; and

FIG. 8 is a block diagram of a data processing system in accordance with an illustrative embodiment.

### DETAILED DESCRIPTION

The illustrative embodiments recognize and take into account one or more different considerations. The illustrative embodiments recognize and take into account that credit ratings are often construction based on the interaction of specific factors and sub-factors. Each factor represents a dimension of the analysis that characterizes a specific risk, a financial ratio, or other observable likely to impact the performance of a rating over time.

The illustrative embodiments also recognize and take into account that quantum computers exploit the unique, non-classical properties of the quantum systems from which they are built, allowing them to process exponentially large quantities of information in only polynomial time.

The illustrative embodiments also recognize and take into account that the study of quantum algorithms has diverged greatly from simply simulating quantum physical systems to impact a wide variety of fields and can be applied to risk analysis of financial instruments.

The illustrative embodiments provide a method for using Schrödinger's equation as a building block in creating a quantum factor representation of a credit rating system. The illustrative embodiments model the factors, sub-factors, and rating outcome as quantum systems, each system having an associated Hamiltonian. The resulting quantum states at a particular time are aggregated to produce a state representing the final rating.

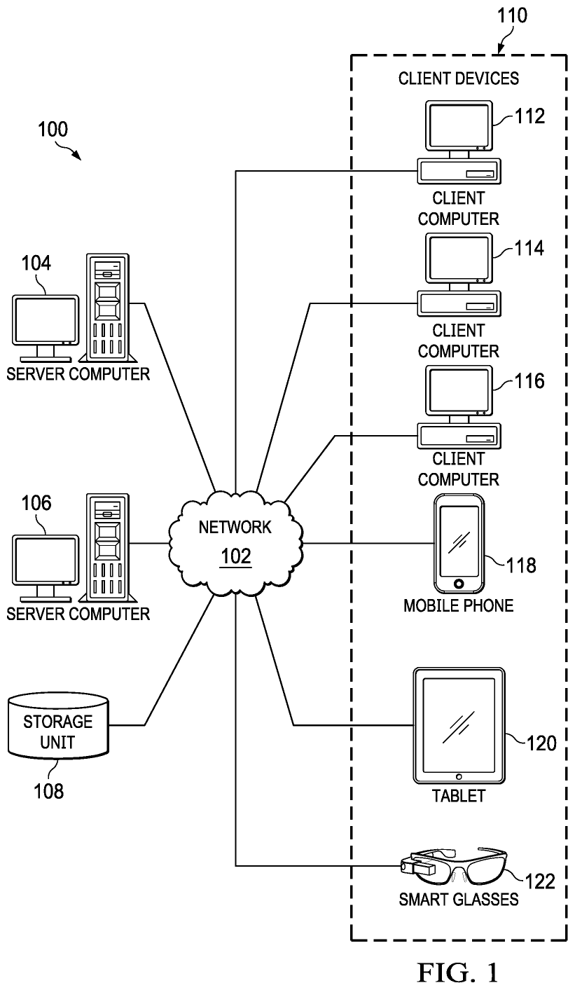

With reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 might include connections, such as wire, wireless communication links, or fiber optic cables.

In the depicted example, server computer 104 and server computer 106 connect to network 102 along with storage unit 108. In addition, client devices 110 connect to network 102. In the depicted example, server computer 104 provides information, such as boot files, operating system images, and applications to client devices 110. Client devices 110 can be, for example, computers, workstations, or network computers. As depicted, client devices 110 include client computers 112, 114, and 116. Client devices 110 can also include other types of client devices such as mobile phone 118, tablet computer 120, and smart glasses 122.

In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, the program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

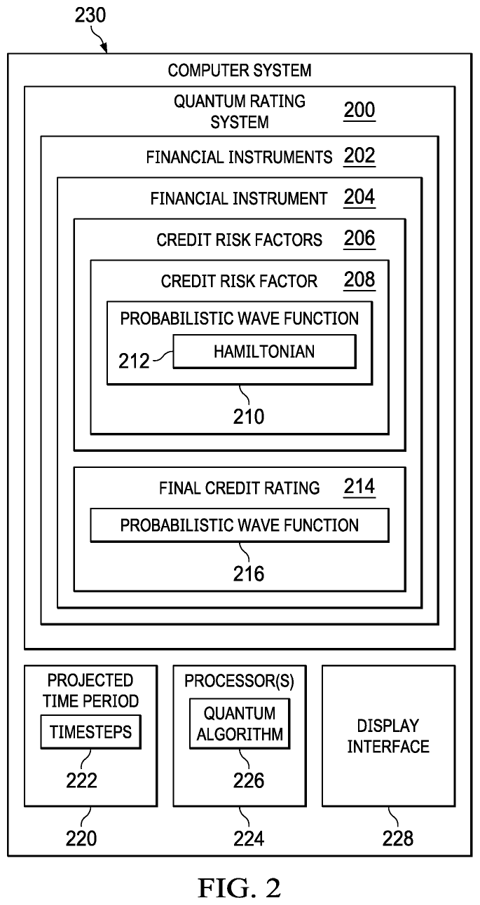

FIG. 2 depicts a block diagram of a quantum rating system in accordance with an illustrative embodiment. Quantum rating system 200 might be implemented in network data processing system 100 in FIG. 1.

Quantum rating system 200 may calculate credit ratings for a number of financial instruments 202. Each financial instrument 204 has a number of associated credit risk factors 206. For each credit risk factor 208, quantum rating system 200 determines a probabilistic wave function 210 that comprises a unique Hamiltonian 212. The probabilistic wave function 210 of the credit risk factor 208 is calculated at a number of timesteps 222 over a projected time period 220 (e.g., 1^{st} second, 2^{nd} second, etc.). At each timestep 222, the calculation comprises a number of iterations (e.g., 1000).

Probabilistic wave function 210 may be calculated using a quantum algorithm 226 running on a number of processors 224.

From the combination of credit risk factors 206, quantum rating system 200 is able to calculate a final credit rating 214 for financial instrument 204. Final credit rating 214 comprises its own probabilistic wave function 216 that is calculated from the linear combination of the probabilistic wave functions 210 of the credit risk factors 206 at each timestep 222.

The probabilistic wave functions 210, 216 for the credit risk factors 206 and final credit rating 214, respectively, may also be displayed to a user on display interface 228.

Quantum rating system 200 can be implemented in software, hardware, firmware or a combination thereof. When software is used, the operations performed by quantum rating system 200 can be implemented in program code configured to run on hardware, such as a processor unit. When firmware is used, the operations performed by quantum rating system 200 can be implemented in program code and data and stored in persistent memory to run on a processor. When hardware is employed, the hardware may include circuits that operate to perform the operations in quantum rating system 200.

As used herein a processor is comprised of hardware circuits such as those on an integrated circuit that respond and process instructions and program code that operate a computer. When a number of processors execute instructions for a process, the processors can be on the same computer or on different computers. In other words, the process can be distributed between processors on the same or different computers in computer system. Further, the number of processors can be of the same type or different type of processors. For example, a number of processors can be selected from at least one of a single core processor, a dual-core processor, a multi-processor core, a general-purpose central processing unit (CPU), a digital signal processor (DSP), or quantum hardware comprising quantum circuits based on qubits (quantum bits).

These components can be located in a computer system 230, which is a physical hardware system and includes one or more data processing systems. When more than one data processing system is present in the computer system, those data processing systems are in communication with each other using a communications medium. The communications medium can be a network. The data processing systems can be selected from at least one of a computer, a server computer, a tablet computer, quantum hardware, or some other suitable data processing system.

Schrödinger's equation is a linear partial differential equation that governs the wave function of a quantum-mechanical system. The most general form of the Schrödinger's equation is shown in Eq. (1):

$$\frac{\partial }{\partial t} \vert ψ ( x , y , z , t ) 〉 = - iH \vert ψ ( x , y , z , t ) 〉 \qquad ( 1 )$$

where ψ(x,y,z,t) represents the probabilistic wave function in three-dimensional space, and as it implies, this is a function of time. The probabilistic wavefunction, ψ(x,y,z,t), of a chemical particle at a certain time represents the superposition state in terms of both its position ((x, y, z) values) in the continuous space and its discrete orbitals. Taking the hydrogen molecule (H₂) as an example, there are four distinguished orbitals the electrons can occupy in the H₂ system: |χ₀ [symbol] , |χ₁ [symbol] , |χ₂ [symbol] and |χ₃ [symbol] . The four orbitals are superposed with the sum of each orbital's probability magnitude equal to one: a²+b²+c²+d²=1 for:

ψ(x,y,z,t)=a|χ₀ [symbol] +b|χ₁ [symbol] +c|χ₂ [symbol] +d|χ₃ [symbol] (2)

Each of the orbitals is described by a continuous spatial-time function:

|χ₀ [symbol] =ψ⁰(x,y,z,t) (3.1)

|χ₁ [symbol] =ψ¹(x,y,z,t) (3.2)

|χ₂ [symbol] =ψ²(x,y,z,t) (3.3)

|χ₃ [symbol] =ψ³(x,y,z,t) (3.4)

In another word, the probabilistic function of the H₂ system can also be written as

ψ(x,y,z,t)=a·ψ⁰(x,y,z,t)+bψ¹(x,y,z,t)+c·ψ²(x,y,z,t)+d·ψ³(x,y,z,t) (4)

If the probabilistic wave function ψ(x,y,z,t) is measured once in terms of the orbitals, then the probabilistic wave function will collapse to one of the probabilistic wave functions of the four orbitals (|χ₀ [symbol] , |χ₁ [symbol] , |χ₂ [symbol] or |χ₃ [symbol] ). If the probabilistic wave function ψ(x,y,z,t) is measured once in terms of the position, then the probabilistic wave function will collapse to one of the infinite amounts of positions in the continuous space at the corresponding time.

The left side of equation (1) represents the time derivative of the wave function, while the right-hand side is the result of the Hamiltonian acting on the wave function scaled by the negative imaginary unit i. The Hamiltonian is the operator that governs the time evolvement of the probabilistic wave function. For example, if the Hamiltonian is replaced with the energy operator for the quantum particle system, the probabilistic wave functions of the quantum particles would be governed by the conservation of energy, and the Hamiltonian corresponds to the total energy of that system, including both kinetic energy and potential energy.

In the procedure for deriving a credit rating it is not unusual to see an approach where the final rating is a construction based on the interaction of specific factors and sub-factors. Each factor represents a dimension of the analysis that characterizes a specific risk, a financial ratio or any other observable likely to impact the performance of a rating over time. These factors and sub-factors are structured in a pipeline that captures their relationship and links the factors and sub-factors to an indicative rating. The pipeline can be rearranged as needed and the concept reused for applications beyond credit ratings.

As an example, the methodology used to rate corporate (i.e., non-financial) obligors is based on two main factors: the business risk profile and the financial risk profile. The values of these factors typically express a gradation of risk from low to high, or the encoding of a financial factor in a similar form. In the case of business risk profile and financial risk profile, the combination of these two factors (usually expressed in a 2×2 matrix) leads to an indicative rating. The values that describe these two main factors are, in turn, derived from combinations of sub-factors (e.g., country risk, industry risk, competitive position, cash flow, and leverage considerations). Each of these sub-factors may, in some cases, be described by further sub-factors. Other factors that are found in the corporate rating methodology include capital structure, liquidity, governance, and ownership structure.

Each of factor and sub-factor involved in the rating of an obligor, can be represented as a probability distribution that varies over time within a specific predefined range. The interplay between the factors determines the final rating outcome which, in turn, is also represented as a time varying probability distribution over the rating scale between the highest possible credit rating on the rating scale (the “AAA state”) and the lowest possible credit rating (the “CCC-state”). It is possible that different combinations of factors and sub-factors may lead to the same final rating.

The illustrative embodiments model credit risk factors and the credit rating outcome as quantum systems, each system having an associated Hamiltonian. The resulting quantum states at a particular time can be aggregated to produce a state representing the final rating. It is this state that will yield the desired probability distribution for the final rating outcome when the probabilistic wave functions for the credit risk factors are measured.

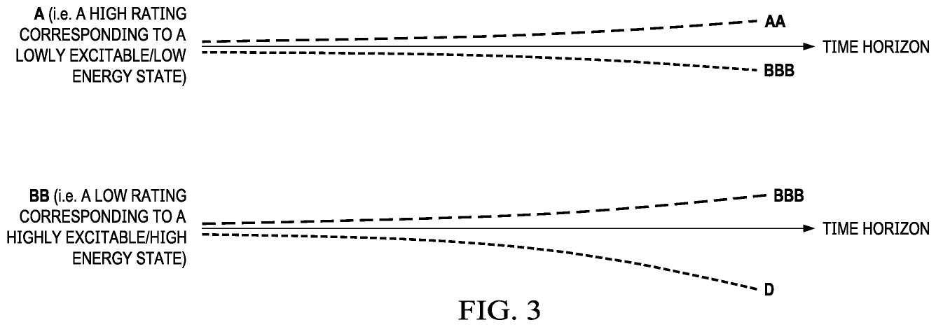

FIG. 3 depicts a diagram illustrating examples of rating state evolutions over time resulting from different volatilities. FIG. 3 illustrates how the final probability distributions should reflect the increased volatility that would be expected with lower rating levels, as opposed to higher rating levels with lower volatility.

The Hamiltonian is a fundamental building block for the Quantum Rating System of the illustrative embodiments and a primary component in the pipelining concept. The illustrative embodiments differ from quantum mechanical modelling scenarios where the Hamiltonian is constructed from potential and kinetic energies of a given system. The method of the illustrative embodiments uses a design approach to construct the best Hamiltonians based on the underlying quantum mechanics and the available quantum computational framework. The illustrative embodiments leverage the structures and energies of various quantum particle systems (e.g., atoms, ions, photons or electrons), the associated energy eigenstates, and other quantum features.

For example, empirical evidence shows that higher credit ratings tend to be more stable than lower ratings. The design of an appropriate Hamiltonian to represent the rating might consider a system where the higher energy eigenstates have higher transition probabilities and therefore mirror, to some extent, the behavior of lower credit ratings. The opposite scenario applies with lower energy eigenstates exhibiting lower transition probabilities used to represent higher credit ratings. In this way, the illustrative embodiments use the features of the Hamiltonian as design features for the required behaviors in the Quantum Rating System.

Considering a quantum system in terms of its superposition of the discrete orbitals, the evolution of the single particle quantum state over time follows from the Hamiltonian and Schrödinger's equation. In the Quantum Rating System, measurements on the quantum state in terms of its orbitals result in a probability distribution across the scale of orbitals in the system. The Hamiltonian allows the illustrative embodiments to evolve the system state over time in a way that correlates with observations of real-world rating transitions over time.

A Quantum Rating System that simulates the time evolution of obligor ratings can be constructed using Schrödinger's equation with appropriately designed Hamiltonians for the credit risk factors and sub-factors that, in aggregate provide the probability distribution of the final rating outcome. In the Quantum Rating System, the discrete credit ratings are the analogy of the discrete orbitals in the physical quantum system. In order to properly simulate that outcome, the general Schrödinger's equation in Equation (1) is simplified to be:

$$\frac{\vert ψ ( x , y , z , t + ϵ ) 〉 - \vert ψ ( x , y , z , t ) 〉}{ϵ} = - iH \vert ψ ( x , y , z , t ) 〉 ⟹ \vert ψ ( x , y , z , t + ϵ ) 〉 = ( I - i ϵ H ) \vert ψ ( x , y , z , t ) 〉 \qquad ( 5 )$$

where ϵ is the timestep increment, H is the corresponding Hamiltonian. According to Equation (2), as long as the timestep increment, ϵ, the Hamiltonian, H, and the initial probabilistic wave function, ψ(x,y,z,t), are known, then the probabilistic wave function at any time after time t can be calculated.

Since Schrödinger's equation is based on the energy and momentum conservation of a quantum system, the Schrödinger equation used in the Quantum Ratings System should also be conservative. However, as time evolves, the inner and outer factors that impact the rating system's probabilistic distribution state varies, and it is quite difficult to keep them conservative. Therefore, by segmenting the time into small timesteps and then concatenating them after the evolvement of each time segmentation, an approximation to a conservative system can be achieved.

In addition, the aggregate structure of the Quantum Rating System may be more or less hierarchical depending on the factors and sub-factors modeled in any given scenario.

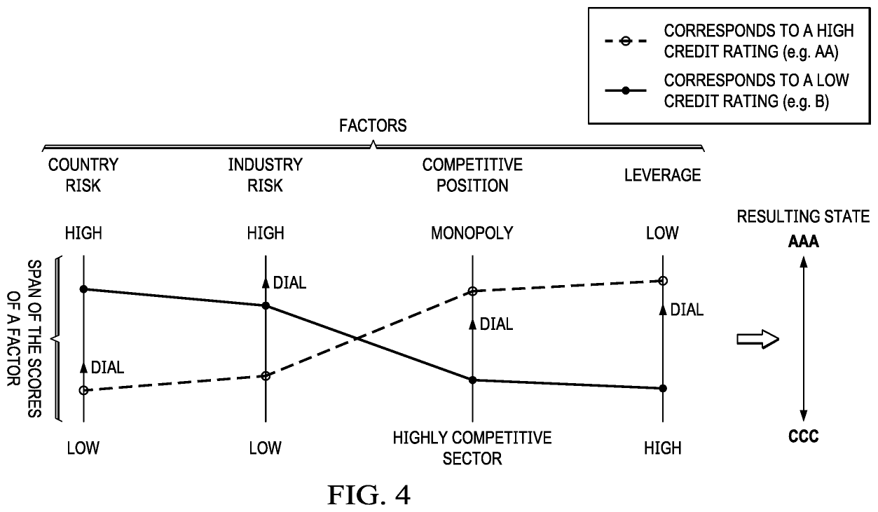

FIG. 4 depicts a diagram illustrating credit risk factors modeled in a Quantum Rating System in accordance with an illustrative embodiment. In the present example, in a corporate rating process, the final rating state is determined from the rating states of four factors: country risk, industry risk, competitive position, and leverage.

Each credit risk factor corresponds to a specific Hamiltonian. If risk factors are composed of sub-factors, those sub-factors would in turn have their own sub-Hamiltonians so forth until the most basic level in the hierarchy is reached. For the process to arrive at an indicative rating, the credit risk factors (and sub-factors) that determine the result are determined sequentially.

The evaluation of each factor may include analysis of the available historical data, current outlooks, peer comparisons, and the expert opinions of credit analysts. There are credit risk factors that are not independent but have a level of correlation that is factored into the analysis on a case-by-case basis.

In the Hamiltonian factor representation, the final credit rating state at any moment is represented by a probabilistic wave function. This probabilistic wave function distribution state evolves with time. Therefore, probabilistic wave functions of credit risk factors may be calculated as quantum systems with two degrees of freedom, wherein one degree of freedom is over credit rating, and the other degree of freedom is over time.

At the end of each timestep, the resulting probabilistic distribution state is composed of its four credit risk factors. Each factor, e.g., the Country Risk, is either composed using other sub-factors or is already the lowest level in the hierarchy and thus governed by its corresponding Hamiltonian.

Correlation effects used in the classical rating approach can be implemented using features of the Quantum Rating System of the illustrative embodiment. As an example, quantum entanglement can be considered as a mechanism to transfer state between two or more credit risk factors.

The Quantum Rating System of the illustrative embodiments can be illustrated with a simplified rating schema comprising four credit risk ratings: AAA, A, BB, CCC. The probabilistic wave function is used to measure a multitude of energy states gradiently associated with the four scores. All energy state squares sum up to one. Alternatively, the quantum state for the reduced rating scale can be expressed as:

|x>=a|AAA>+b|A>+c|BB>+d|CCC>

where |a|\hat{ }2 is the probability of observing a AAA rating.

Two qubits are assigned to the rating system, which can form four states (|00 [symbol] , |01 [symbol] , |10 [symbol] , |11 [symbol] ), with the assumption that each state representing an orbital (χ₀, χ₁, χ₂, χ₃) in the hydrogen system, and with each orbital representing a rating forming the rating scale (AAA, A, BB, CCC) (for the full rating scale actually used in financial markets, more qubits are required):
χ₀ [symbol] :AAA
χ₁ [symbol] :A
χ₂ [symbol] :BB
χ₃ [symbol] :CCC

The initial probabilistic distribution of all four factors is uniform, meaning at time=0, all four factors are in the state: ∥χ₀∥²=∥χ₁∥²=∥χ₂∥²=∥χ₃∥²=0.25.

The corresponding Hamiltonian for each variable is determined by how well its energy spectrum, and other features fit the required behavior:

Country Risk Factor:H_{CR}=0.5678I⊗Z−1.4508Z⊗I+0.6799Z⊗Z+0.0791Y⊗Y+0.0791Z⊗Z (a)

Industry Risk Factor:H_{IR}=0.2895Z⊗Z−0.2845Y⊗I+0.5327I⊗Z+0.097Y⊗X+0.097X⊗X (b)

Competitive Position Factor:H_{CP}=0.1472Y⊗Y+0.0052X⊗Z+0.3992I⊗X+0.127Z⊗I+0.127X⊗Y (c)

Leverage Factor:H_{L}=0.1098Y⊗I+0.0549X⊗X+0.3521Z⊗Z+0.1412I⊗Y+0.1412Z⊗Y (d)

It is possible to construct Hamiltonians that perform well as approximations of the stochastic time evolution of the relevant factors. For example, Pauli operators may be used as a foundation, where I, X, Y, Z are identity, pauliX, pauliY and pauliZ Hamiltonians, respectively. More complex operators may be used as a method of including greater stochastic perturbation.

After every timestep, ϵ, the resulting state, ψ_{final} is calculated from combining the state of four factors:

ψ_{final}(x,y,z,t)=e₀ψ₀(x,y,z,t)+e₁ψ₁(x,y,z,t)+e₂ψ₂(x,y,z,t)+e₃ψ₃(x,y,z,t) (6)

where e₀, e₁, e₂, and e₃ are the expected values of four factors' states, respectively. It should be always true that e₀+e₁+e₂+e₃=1, so that the final resulting state's square sum are guaranteed to be one.

Instead of taking the ending states of the previous timestep as the initial states of the current timestep and then calculating the state evolvement, the ending state of the current timestep may be calculated with time evolvement starting from time=0 to the end of current timestep.

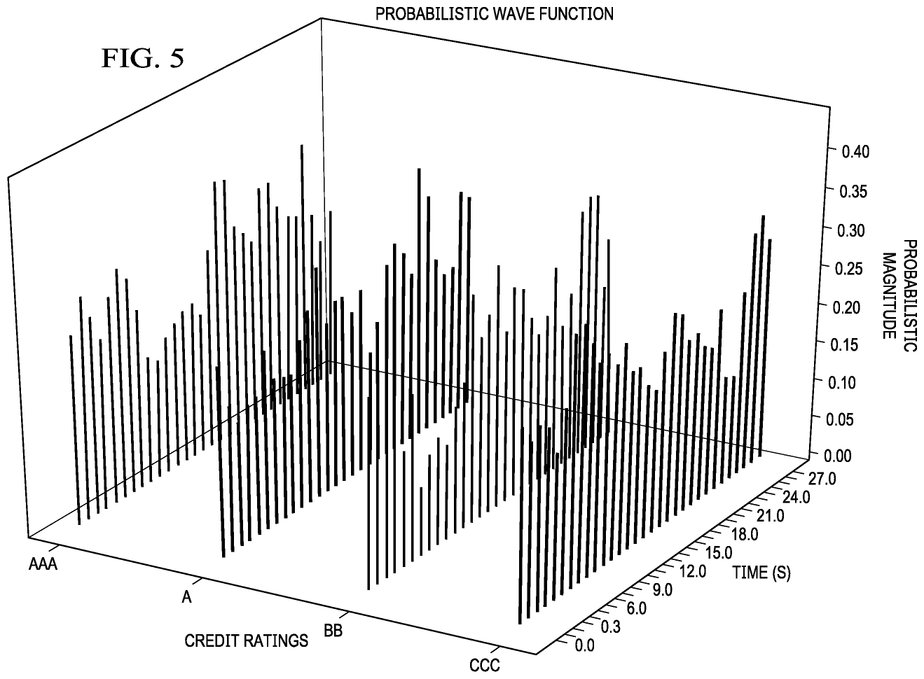

FIG. 5 depicts a diagram illustrating final credit ratings as shifting probability distributions over time in accordance with an illustrative embodiment. FIG. 5 illustrates how ratings can be constructed from the shift in probability distribution as well as the pipelining of Hamiltonians used to calculate the final rating. It should be noted that the P-axis (the ‘Probabilistic Magnitude’ axis) is the probabilistic magnitude for the wave function.

Equation (2) provides a way to calculate the rating system's instantaneous probabilistic distribution of the credit ratings. As shown in FIG. 5, ψ represents the function of the waves, and it depends on two independent parameters, the rating score, x, and the time, t. The P axis indicates the probabilistic magnitude of ψ at a certain credit rating (i.e., AAA, A BB, CCC) and at a certain time (e.g., t=15 seconds). It is worth noting that the function |ψ(x,y,z,t) [symbol] is continuous in terms of the position, but discrete in terms of the orbitals. In this study, we only measure its discrete orbitals analogies: the credit ratings. In addition, because ψ(x,y,z,t) is a probabilistic wave function, its magnitude along the credit rating axis at a certain time t should sum to 100% (in another words, 1). The terms |ψ(x,y,z,t) [symbol] and |ψ(x,y,z,t+ϵ) [symbol] in the equation represent the rating system's probabilistic distribution of the credit ratings at the time t and at the time t+ϵ, respectively.

The equation (|ψ(x,y,z,t+ϵ) [symbol] =(I−iϵH)|ψ(x,y,z,t) [symbol] ) means: given the initial probabilistic wave function, the probabilistic wave function is determined at a following time, which is ψ at t+ϵ. For example, the initial probabilistic wave function at time=t=0 second, might be:

|ψ(x,y,z,t) [symbol] =ƒ(x)={40%@χ₀=AAA;30%@χ₁=A;25%@χ₂=BB;5%@χ₃=CCC}

which means at time t=0, the corresponding probabilistic wave function, |ψ(x,y,z,t) [symbol] , is distributed such that it has a 40% chance of being measured as AAA, 30% chance of being A; 25% chance of being BB; and 5% chance of being CCC.

If ϵ=1 second, then |ψ(x,y,z,t+ϵ) [symbol] means the probabilistic wave function at time=t+ϵ=1 second.

|ψ(x,y,z,t+ϵ) [symbol] is determined with |ψ(x,y,z,t) [symbol] by applying the operator (I−iϵH) on the state |ψ(x,t) [symbol] , where I is the identity operator, i is the imaginary term, ϵ is the timestep (e.g., ϵ=1 second), and H is the Hamiltonian operator of the corresponding states.

For example, if the system is the analogue of the hydrogen molecule system, then H should be the Hamiltonian operator of the hydrogen molecule system. Given the complexity of H, in the pipeline coding, H may be randomly assumed. The process is repeated iteratively during the whole period of wave function's evolution. For example, at the first step, the initial state is |ψ(x,y,z,t=0 second) [symbol] , and the wanted state is |ψ(x,y,z,t=t+ϵ=1 second) [symbol] . At the following step, the initial state becomes |ψ(x,y,z,t=1 second) [symbol] , and the wanted state becomes |ψ(x,y,z,t=t+ϵ=2 second) [symbol] , and so on so forth until the end of the whole evolution period of the wave function.

The illustrative embodiments decompose the Hamiltonians corresponding to the final rating into sub-components representing the credits risk factors and sub-factors of the Quantum Rating System. The Hamiltonian associated with the final rating incorporates all the credit risk factors and sub-factors that drive the probabilistic outputs of the system. With this approach, the illustrative embodiments provide a good approximation for the stochastic time evolution of credit ratings.

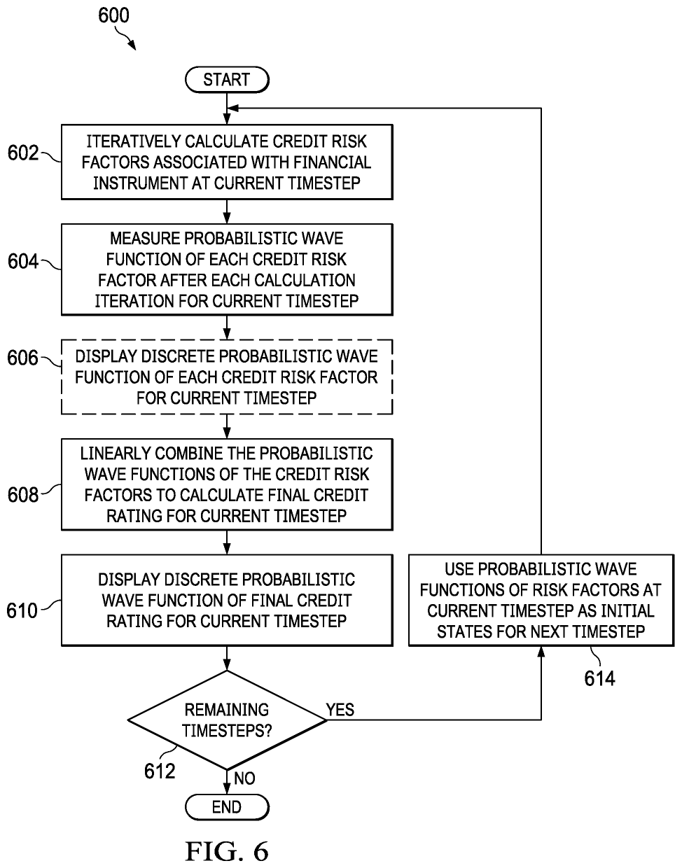

FIG. 6 depicts a flowchart illustrating a process for rating credit risk at a given timestep in accordance with an illustrative embodiment. The process 600 can be implemented in hardware, software, or both. When implemented in software, the process can take the form of program code that is run by one of more processors located in one or more hardware devices in one or more computer systems. Process 600 might be implemented in quantum rating system 200 shown in FIG. 2.

Process 600 begins by calculating a number of credit risk factors associated with a financial instrument (step 602). The credit risk factors may include, e.g., country risk, industry risk, competitive position of the company relative to other companies, and leverage.

Each credit risk factor calculated iteratively (e.g., 1000 times) at a first timestep as a discrete probabilistic wave function representing a superposition state of scores. At the beginning of the projected time period comprising the first and subsequent timesteps, the credit risk factors may be set with an initial probabilistic distribution that is uniform, Gaussian, or delta. Each discrete probabilistic wave function comprises a comparison of volatility versus stability over time. The volatility of each credit risk factor corresponds to the kinetic energy of a specific Hamiltonian corresponding to the credit risk factor.

Process 600 measures the discrete probabilistic wave function of each credit risk factor after each calculation iteration for the first timestep (step 604). Each measurement causes collapse of the credit risk factor's superposition state, resulting in a deterministic score. The discrete probabilistic wave function of each credit risk factor is the aggregation of probabilistic distribution of the repeatedly measured score at the first timestep.

Process 600 may optionally display the discrete probabilistic wave function of each credit risk factor in a user interface (step 606).

The probabilistic wave functions of the credit risk factors are linearly combined to calculate a discrete probabilistic wave function for a final credit rating of the financial instrument for the first timestep (step 608).

The discrete probabilistic wave function of the final credit rating for the first timestep is then displayed in a user interface (step 610). The final credit rating may be represented as a shifting probability distribution over time within a credit rating schema, wherein the credit rating schema is represented by states of a number of assigned qubits.

If there are additional timesteps to calculate (step 612), steps 602-610 are repeated for a second (next) timestep, wherein the probabilistic wave functions of the credit risk factors at the first timestep serve as initial states for the second timestep.

If there are no more timesteps, process 600 then ends.

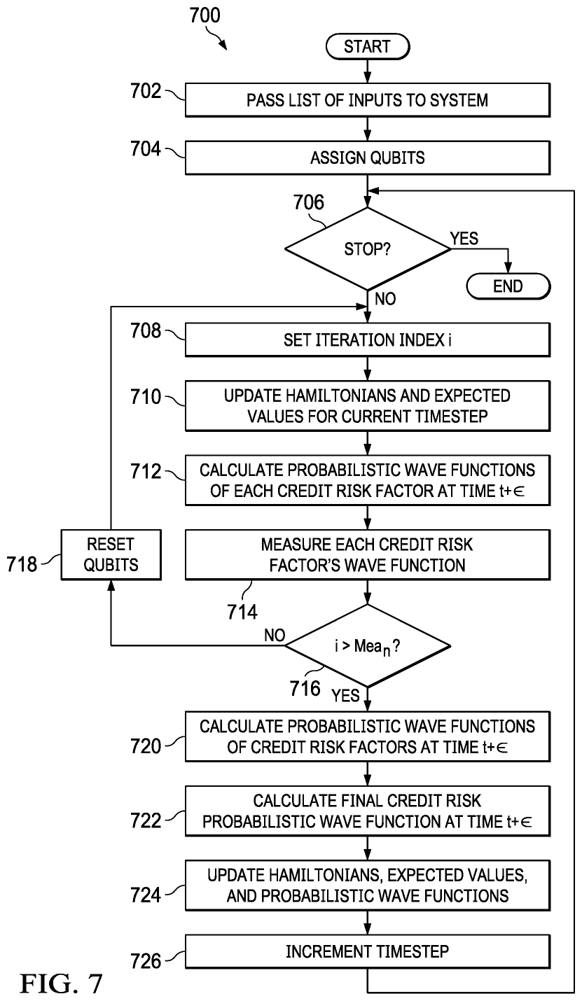

FIG. 7 depicts a flowchart illustrating a process for calculating probabilistic wave functions over in accordance with an illustrative embodiment. FIG. 7 is a more detailed description of the calculation steps in process 600 over a full series of timesteps.

Process 700 begins by passing a list of inputs to the system (e.g., quantum rating system 200) (step 702). The inputs may comprise a timestep value E. The initial value may be assigned ϵ=1 second. As described above, there are four credit risk factors comprising the Country Risk Factor, the Industry Risk Factor, the Competitive Position Factor, and the Leverage Factor. Each of the factors is assumed to have an initial probabilistic wave function: ψ₀(x,y,z,t), ψ₁(x,y,z,t), ψ₂ (x,y,z,t), and ψ₃(x,y,z,t), respectively and respective Hamiltonians H₀, H₁, H₂, and H₃.

The credit risk factors also have expected values e₀, e₁, e₂, and e₃ for their respective wave functions. The final credit rating's wave function ψ_{final}(x,y,z,t) is calculated from

ψ_{final}(x,y,z,t)=e₀ψ₀(x,y,z,t)+e₁ψ₁(x,y,z,t)+e₂ψ₂(x,y,z,t)+e₃ψ₃(x,y,z,t) (7)

wherein e₀, e₁, e₂, and e₃ are defined to make sure the total probabilistic magnitude of ψ_{final}(x,y,z,t) is always 1. For example, it may be assumed e₀=e₁=e₂=e₃=0.25, which means each of the sub-factor contribute equally to the final factor.

Another input is Measurement time: Meaₙ. This parameter is used because of the qubits used to represent the rating system's states, and each quantum state corresponding to a score. Because of the superposition property of the qubits, at a given time, each credit risk has a wave function, meaning it can be measured at different scores with different probabilities. For example, at t=0 second, ψ₀(x,y,z,t) has 20% of chance to be measured as AAA; 30% of chance to be measured as A; 50% of chance to be measured as BB; and 0% of chance to be measured as CCC. However, due to the fact that the qubit's state collapses from a superposition state to a deterministic state, a one-time measurement on the qubits would not provide the probabilistic distribution of the qubit's superposition state. Therefore, to better understand the superposition states, the qubits are prepared at their original superposition states for hundreds of times and measured. The number of iterations for this preparation and measurement actions is called the measurement time, Meaₙ.

For example, if ψ₀(x,y,z,t) is in a superposition state that is unknown, and Meaₙ=1000, after 1000 times preparation and measurement, the results may show that the qubits collapse to the state corresponding to the score AAA for 200 hundred times, to the state corresponding to the score A for 300 hundred times, to the state corresponding to the score BB for 500 hundred times, and to the state corresponding to CCC for 0 times, corresponding to the example above.

Next qubits are assigned to the system (step 704). The qubits may be assigned to represent different states of the rating system. Using the example above, two qubits may be assigned to the rating system (i.e., |00 [symbol] :AAA, |01 [symbol] :A, |10 [symbol] :BB, |11 [symbol] :CCC).

The system next determines if there is a timestep for which to determine the credit rating (step 706). If there are no more timesteps, process 700 ends.

If there is a remaining timestep, process 700 sets the iteration index i for that timestep (e.g., i=0) (step 708).

Process 700 then updates the Hamiltonians and expected values for the current timestep (step 710). The values may be used from a previous timestep. Intermediate Hamiltonian and expectation values may be used to replace the previous ones:

H_{0_new}=H₀;e_{0_new}=e₀

H_{1_new}=H₁;e_{1_new}=e₁

H_{2_new}=H₂;e_{2_new}=e₂

H_{3_new}=H₃;e_{3_new}=e₃

Next, process 700 calculates the probabilistic wave function of each credit risk factor at the current timestep (e.g., t+ϵ) (step 712):

|ψ₀_{_{new}}(x,y,z,t+ϵ) [symbol] =(I−iϵH_{0_new})|ψ₀(x,y,z,t)

[symbol]

|ψ₁_{_{new}}(x,y,z,t+ϵ) [symbol] =(I−iϵH_{1_new})|ψ₁(x,y,z,t)

[symbol]

|ψ₂_{_{new}}(x,y,z,t+ϵ) [symbol] =(I−iϵH_{2_new})|ψ₂(x,y,z,t)

[symbol]

|ψ₃_{_{new}}(x,y,z,t+ϵ) [symbol] =(I−iϵH_{3_new})|ψ₃(x,y,z,t)

[symbol]

Process 700 then measures each credit risk factor's wave function (step 714):
Measure |ψ₀_{_{new}}(x,y,z,t+ϵ) [symbol] , and it can be either |00 [symbol] (corresponding to the score AAA), |01 [symbol] (corresponding to the score A), |10 [symbol] (corresponding to the score BB) or |11 [symbol] (corresponding to the score CCC)
Measure |ψ₁_{_{new}}(x,y,z,t+ϵ) [symbol] , and it can be either |χ₀ [symbol] , |χ₁ [symbol] , |χ₂ [symbol] or |χ₃ [symbol]
Measure |ψ₂_{_{new}}(x,y,z,t+ϵ) [symbol] , and it can be either |χ₀ [symbol] , |χ₁ [symbol] , |χ₂ [symbol] or |χ₃ [symbol]
Measure |ψ₃_{_{new}}(x,y,z,t+ϵ) [symbol] , and it can be either |χ₀ [symbol] , |χ₁ [symbol] , |χ₂ [symbol] or |χ₃

[symbol]

Steps 710-714 comprise one iteration i of the inner loop for the current timestep. This process is repeated for the specific measurement time (e.g., Meaₙ=1000 times), producing the probabilistic distribution of the four credit risk factors, respectively.

After each iteration, process 700 determines if i has reached the specified number of iterations for Meaₙ (step 716). If the iteration index i has not yet reach the specified number of iterations for Meaₙ, the qubits are reset (step 718), and the interaction index i is set for the next iteration (step 708).

When the iteration index i reaches the specified threshold for Meaₙ, process 700 exits the inner loop.

After exiting from the inner loop, process 700 calculates the probabilistic wave function of each credit risk factor at the current timestep (e.g., t+ϵ) (step 720). For example, for the first sub-factor, in 1000 measurements, the system of qubits might collapse to |11 [symbol] for 250 times, to |10 [symbol] for 100 times, to |01 [symbol] for 500 times and to |00 [symbol] for 150 times. Therefore, |ψ₀_{_{new}}(x,y,z,t+ϵ) [symbol] =0.25 CCC+0.1 BB+0.5 A+0.15 AAA. This means the first credit risk factor has 25% chance to be measured as CCC, 10% chance to be measured as BB, 50% chance to be measured as A and 15% chance to be measured as AAA at the current timestep t+ϵ.

Next, process 700 calculates probabilistic wave function of the final credit rating at the current timestep (step 722):

|ψ_{final}(x,y,z,t+ϵ) [symbol] =e₀|ψ₀_{_{new}}(x,y,z,t+ϵ) [symbol] +e₁|ψ₁_{_{new}}(x,y,z,t+ϵ) [symbol] +e₂|ψ₂_{_{new}}(x,y,z,t+ϵ) [symbol] +e₃|ψ₃_{_{new}}(x,y,z,t+ϵ)

[symbol]

Process 700 then assigned the current Hamiltonians (H_{0_new}, H_{1_new}, H_{2_new}, H_{3_new}), expected values (e_{0_new}, e_{1_new}, e_{2_new}, e_{3_new}), and probabilistic wave functions (|ψ₀_{_{new}}(x,y,z,t+ϵ) [symbol] , |ψ₁_{_{new}}(x,y,z,t+ϵ) [symbol] , |ψ₂_{_{new}}(x,y,z,t+ϵ) [symbol] , |ψ₃_{_{new}}(x,y,z,t+ϵ) [symbol] ) in place the previous Hamiltonians (H₀, H₁, H₂ and H₄), expected values (e₀, e₁, e₂, e₃), and probabilistic wave functions (|ψ₀(x,y,z,t) [symbol] , |ψ₁(x,y,z,t) [symbol] , |ψ₂(x,y,z,t) [symbol] , |ψ₃(x,y,z,t) [symbol] ) (step 724). This step is performed because, in the outer loop, to determine the final credit rating's probabilistic wave function at the next time step (e.g., at 2 seconds), the probabilistic wave function at the current timestep (i.e., 1 second) can be used as the initial state, and repeat the steps above.

Process 700 then increments the timestep (step 726) and returns to step 706. Steps 706-726 can be repeated until at a specified timestep threshold (e.g., 30 seconds) is reached, at which point process 700 ends.

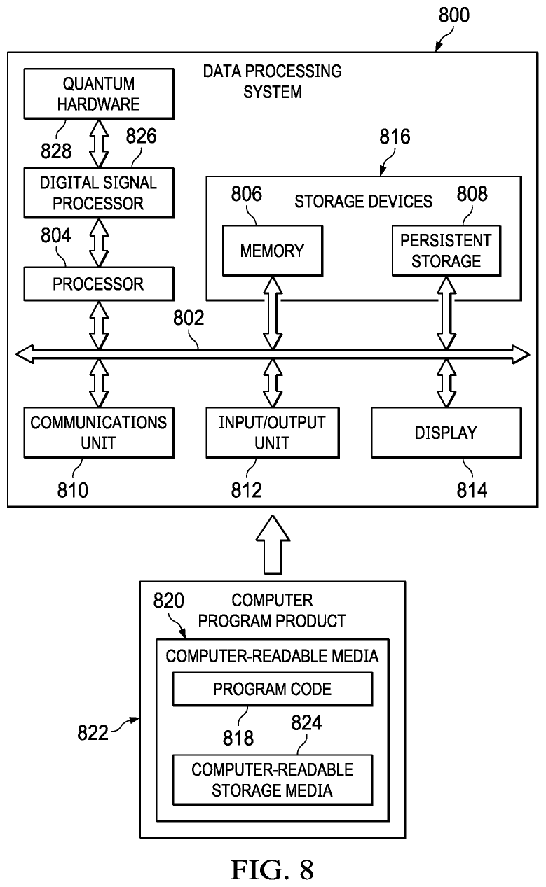

Turning now to FIG. 8, a block diagram of a data processing system is depicted in accordance with an illustrative embodiment. Data processing system 800 can be used to implement server computer 104, server computer 106, client devices 110, in FIG. 1. Further, data processing system 800 can also be used to implement one or more components in quantum rating system 200 in FIG. 2. In this illustrative example, data processing system 800 includes communications framework 802, which provides communications between processor unit 804, memory 806, persistent storage 808, communications unit 810, input/output (I/O) unit 812 and display 814. In this example, communications framework 802 takes the form of a bus system.

Processor unit 804 serves to execute instructions for software that can be loaded into memory 806. Processor unit 804 may include one or more processors such as central processors units (CPUs). Processor unit 804 may send instructions to and from digital signal processor (DSP) 826. DSP 826 in turn sends analog or hybrid signals to and from quantum hardware 828.

Quantum hardware 828 may comprise quantum circuits based on qubits (quantum bits). Qubits are traditionally used to simulate a 1 or 0 state, or in a superposition of the 1 and 0 states. However, when measured, the qubit may be in an infinite number of states depending on the qubit's quantum state immediately prior to measurement when using a Bloch sphere representation. The quantum circuits may comprise a number of reversible quantum gates in which computational processes are logically reversible.

Memory 806 and persistent storage 808 are examples of storage devices 816. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 816 may also be referred to as computer-readable storage devices in these illustrative examples. Memory 806, in these examples, can be, for example, a random-access memory or any other suitable volatile or non-volatile storage device. Persistent storage 808 may take various forms, depending on the particular implementation.

Persistent storage 808 may contain one or more components or devices. For example, persistent storage 808 can be a hard drive, a solid-state drive (SSD), a flash memory, a rewritable optical disk, a rewritable magnetic tape, or some combination of the above. The media used by persistent storage 808 also can be removable. For example, a removable hard drive can be used for persistent storage 808.

Communications unit 810, in these illustrative examples, provides for communications with other data processing systems or devices. In these illustrative examples, communications unit 810 is a network interface card.

Input/output unit 812 allows for input and output of data with other devices that can be connected to data processing system 800. For example, input/output unit 812 may provide a connection for user input through at least one of a keyboard, a mouse, or some other suitable input device. Further, input/output unit 812 may send output to a printer. Display 814 provides a mechanism to display information to a user.

Instructions for at least one of the operating system, applications, or programs can be located in storage devices 816, which are in communication with processor unit 804 through communications framework 802. The processes of the different embodiments can be performed by processor unit 804 using computer-implemented instructions, which may be located in a memory, such as memory 806.

These instructions are referred to as program code, computer usable program code, or computer-readable program code that can be read and executed by a processor in processor unit 804. The program code in the different embodiments can be embodied on different physical or computer-readable storage media, such as memory 806 or persistent storage 808.

Program code 818 is located in a functional form on computer-readable media 820 that is selectively removable and can be loaded onto or transferred to data processing system 800 for execution by processor unit 804. Program code 818 and computer-readable media 820 form computer program product 822 in these illustrative examples. In the illustrative example, computer-readable media 820 is computer-readable storage media 824.

In these illustrative examples, computer-readable storage media 824 is a physical or tangible storage device used to store program code 818 rather than a medium that propagates or transmits program code 818.

Alternatively, program code 818 can be transferred to data processing system 800 using a computer-readable signal media. The computer-readable signal media can be, for example, a propagated data signal containing program code 818. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 820” can be singular or plural. For example, program code 818 can be located in computer-readable media 820 in the form of a single storage device or system. In another example, program code 818 can be located in computer-readable media 820 that is distributed in multiple data processing systems. In other words, some instructions in program code 818 can be located in one data processing system while other instructions in program code 818 can be located in a separate data processing system. For example, a portion of program code 818 can be located in computer-readable media 820 in a server computer while another portion of program code 818 can be located in computer-readable media 820 located in a set of client computers.

The different components illustrated for data processing system 800 are not meant to provide architectural limitations to the manner in which different embodiments can be implemented. The different illustrative embodiments can be implemented in a data processing system including components in addition to or in place of those illustrated for data processing system 800. Other components shown in FIG. 8 can be varied from the illustrative examples shown. The different embodiments can be implemented using any hardware device or system capable of running program code 818.

The description of the different illustrative embodiments has been presented for purposes of illustration and description and is not intended to be exhaustive or limited to the embodiments in the form disclosed. In some illustrative examples, one or more of the components may be incorporated in or otherwise form a portion of, another component. For example, the 806, or portions thereof, may be incorporated in processor unit 804 in some illustrative examples.

As used herein, “a number of,” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method of rating credit risk, the method comprising:
using a number of processors to perform the steps of:
calculating a number of credit risk factors associated with a financial instrument, wherein each credit risk factor is calculated iteratively at a first timestep as a discrete probabilistic wave function representing a superposition state of scores;
measuring, after each calculation iteration, the discrete probabilistic wave function of each credit risk factor for the first timestep;
linearly combining the probabilistic wave functions of the credit risk factors to calculate a discrete probabilistic wave function for a final credit rating of the financial instrument for the first timestep;
displaying, in a user interface, the discrete probabilistic wave function of the final credit rating for the first timestep; and
repeating the above steps for a second timestep, wherein the probabilistic wave functions of the credit risk factors at the first timestep serve as initial states for the second timestep.

2. The method of claim 1, further comprising displaying the discrete probabilistic wave function of each credit risk factor.

3. The method of claim 1, wherein each credit risk factor discrete probabilistic wave function comprises a comparison of volatility versus stability over time.

4. The method of claim 1, wherein the probabilistic wave functions of the credit risk factors are calculated as quantum systems with two degrees of freedom, wherein one degree of freedom is over credit ratings, and the other degree of freedom is over time.

5. The method of claim 1, wherein each credit risk factor has a specific corresponding Hamiltonian.

6. The method of claim 5, wherein volatility of the credit risk factors corresponds to kinetic energy of the Hamiltonian.

7. The method of claim 1, wherein, at the beginning of a projected time period comprising the first and second timesteps, the credit risk factors are set with an initial probabilistic distribution that is:
uniform;
Gaussian; or
delta.

8. The method of claim 1, wherein the final credit rating is represented as a shifting probability distribution over time within a credit rating schema.

9. The method of claim 8, wherein the credit rating schema is represented by states of a number of assigned qubits.

10. The method of claim 1, wherein the credit risk factors comprise at least one of:
country risk;
industry risk;
competitive position; or
leverage.

11. A system for rating credit risk, the system comprising:
a storage device configured to store program instructions; and
one or more processors operably connected to the storage device and configured to execute the program instructions to cause the system to:
calculate a number of credit risk factors associated with a financial instrument, wherein each credit risk factor is calculated iteratively at a first timestep as a discrete probabilistic wave function representing a superposition state of scores;
measure, after each calculation iteration, the discrete probabilistic wave function of each credit risk factor for the first timestep;
linearly combine the probabilistic wave functions of the credit risk factors to calculate a discrete probabilistic wave function for a final credit rating of the financial instrument for the first timestep;
display, in a user interface, the discrete probabilistic wave function of the final credit rating for the first timestep; and
repeat the above steps for a second timestep, wherein the probabilistic wave functions of the credit risk factors at the first timestep serve as initial states for the second timestep.

12. The system of claim 11, further comprising displaying the discrete probabilistic wave function of each credit risk factor.

13. The system of claim 11, wherein each credit risk factor discrete probabilistic wave function comprises a comparison of volatility versus stability over time.

14. The system of claim 11, wherein the probabilistic wave functions of the credit risk factors are calculated as quantum systems with two degrees of freedom, wherein one degree of freedom is over credit ratings, and the other degree of freedom is over time.

15. The system of claim 11, wherein each credit risk factor has a specific corresponding Hamiltonian.

16. The system of claim 15, wherein volatility of the credit risk factors corresponds to kinetic energy of the Hamiltonian.

17. The system of claim 11, wherein, at the beginning of a projected time period comprising the first and second timesteps, the credit risk factors are set with an initial probabilistic distribution that is:
uniform;
Gaussian; or
delta.

18. The system of claim 11, wherein the final credit rating is represented as a shifting probability distribution over time within a credit rating schema.

19. The system of claim 18, wherein the credit rating schema is represented by states of a number of assigned qubits.

20. The system of claim 11, wherein the credit risk factors comprise at least one of:
country risk;
industry risk;
competitive position; or
leverage.

21. A computer program product for rating credit risk, the computer program product comprising:
a computer-readable storage medium having program instructions embodied thereon to perform the steps of:
calculating a number of credit risk factors associated with a financial instrument, wherein each credit risk factor is calculated iteratively at a first timestep as a discrete probabilistic wave function representing a superposition state of scores;
measuring, after each calculation iteration, the discrete probabilistic wave function of each credit risk factor for the first timestep;
linearly combining the probabilistic wave functions of the credit risk factors to calculate a discrete probabilistic wave function for a final credit rating of the financial instrument for the first timestep;
displaying, in a user interface, the discrete probabilistic wave function of the final credit rating for the first timestep; and
repeating the above steps for a second timestep, wherein the probabilistic wave functions of the credit risk factors at the first timestep serve as initial states for the second timestep.

22. The computer program product of claim 21, further comprising displaying the discrete probabilistic wave function of each credit risk factor.

23. The computer program product of claim 21, wherein each credit risk factor discrete probabilistic wave function comprises a comparison of volatility versus stability over time.

24. The computer program product of claim 21, wherein the probabilistic wave functions of the credit risk factors are calculated as quantum systems with two degrees of freedom, wherein one degree of freedom is over credit ratings, and the other degree of freedom is over time.

25. The computer program product of claim 21, wherein each credit risk factor has a specific corresponding Hamiltonian.

26. The computer program product of claim 25, wherein volatility of the credit risk factors corresponds to kinetic energy of the Hamiltonian.

27. The computer program product of claim 21, wherein, at the beginning of a projected time period comprising the first and second timesteps, the credit risk factors are set with an initial probabilistic distribution that is:
uniform;
Gaussian; or
delta.

28. The computer program product of claim 21, wherein the final credit rating is represented as a shifting probability distribution over time within a credit rating schema.

29. The computer program product of claim 28, wherein the credit rating schema is represented by states of a number of assigned qubits.

30. The computer program product of claim 21, wherein the credit risk factors comprise at least one of:
country risk;
industry risk;
competitive position; or
leverage.
